(19) United States
(12) Patent Application Publication
(10) Pub. No.: US 2025/0190223 A1
(43) Pub. Date: Jun. 12, 2025

(54) PROCESSING UNIT, SOFTWARE MODULE, METHODS AND PROGRAM CODES

(71) Applicant: Intel Corporation, Santa Clara, CA (US)

(72) Inventors: Shihui LI, Shanghai (CN); Ching Sia LIM, George Town (MY); Rashmi NAGABHUSHANA, Bangalore (IN); Krishna PAUL, Bangalore (IN); Usharani AYYALASOMAYAJULA, Bangalore (IN); Thomas TLUSTY, Hood River, OR (US)

(21) Appl. No.: 18/845,897

(22) PCT Filed: Apr. 12, 2022
(86) PCT No.: PCT/CN2022/086416

§ 371 Date: Sep. 11, 2024

(51) Int. Cl. G06F 9/4401; G06F 11/30

(52) U.S. Cl. CPC G06F 9/4401; G06F 11/3055

(57) ABSTRACT

A device is provided. The device includes one or more interfaces configured to communicate with a plurality of random-access memories (RAM) and processing circuitry configured to control the one or more interfaces and to transmit a load message to each RAM of the plurality of RAM and determine a status of each RAM of the plurality of RAM.

### BACKGROUND

Currently, partial of silicon initialization has been moved to intellectual property (IP) firmware (FW) on micro cores (μC), like subsystem with μC being used for High Bandwidth Memory (HBM) and Dual Data Rate (DDR) signal training separately.

For some IP, like HBM, after performing an IP initialization, the related μC of a processing device may be shut down with a static random-access memory idle (SRAM). While other IP FW on the processing device, like DDR training, may run with very limited SRAM for big chunks of code on μC, such that big IP FW may be chopped into small pieces to load one by one. Thus, there may be need to increase a memory access of a processing device.

### BRIEF DESCRIPTION OF THE FIGURES

Some examples of apparatuses and/or methods will be described in the following by way of example only, and with reference to the accompanying figures, in which

FIG. 1 shows a block diagram of an example of a device;

FIG. 2 shows an example of a method for a device;

FIG. 3 shows another example of a method for a device;

FIG. 4 shows an example of a condition of an IP B according to the prior-art and according to another example of method for a device;

FIG. 5 shows a block diagram of an example of a RAM;

FIG. 6 shows an example of a method for a RAM;

FIG. 7 shows a flow diagram of another example of a method for a RAM; and

FIG. 8 shows a computing device.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

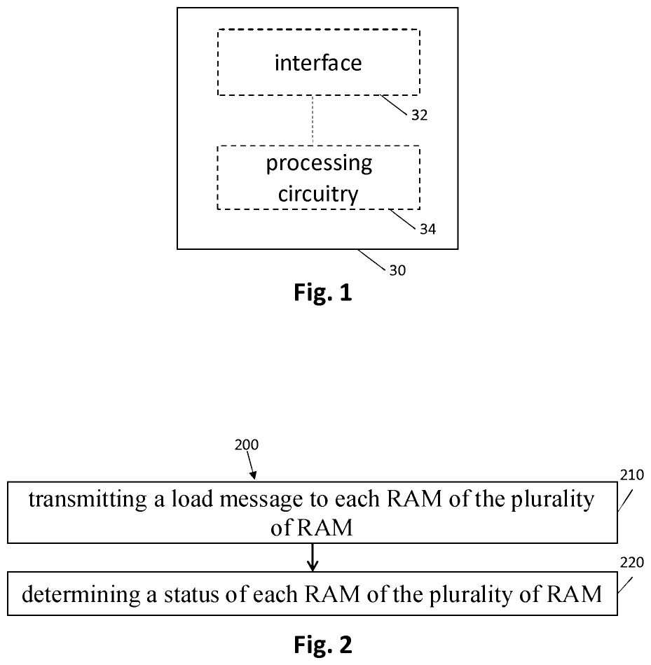

FIG. 1 shows a block diagram of an example of a device 30. The device 30 comprises one or more interfaces 32 configured to communicate with a plurality of random-access memories (RAM) and a processing circuitry 34 configured to control the one or more interfaces 32. Further, the processing circuitry 34 is configured to transmit a load message to each RAM of the plurality of random-access memories and determine a status of each RAM of the plurality of RAM. Thus, the processing circuitry 34 can collect information about a status of each RAM, e.g., about a workload of each RAM, an operation state, such as idle mode, etc. The information about the status of each RAM can be used to maintain an IP initialization. This way, the RAM of the device 30 can be used in an improved way. For example, a leverage of idle (S) RAM from an idle μC subsystem can be achieved. The idle(S) RAM can be another μC subsystem that is short of this resource to finish an IP initialization, e.g., in a system boot phase (but not runtime). The RAM may be a volatile memory, e.g., DRAM, SRAM.

For example, a resources intensive IP initialization of an IP FW may run on a limited RAM of a μC. Maintaining the IP initialization, e.g., reassigning the IP initialization (e.g., at least partially) to another μC, can omit both enlarging the RAM for this IP initializing and chopping the IP initializing into pieces and load the pieces one by one. Thus, an IP initialization of a resources intensive IP FW can be improved. An enlargement of the RAM of the device 30, which will increase the cost of a processor can be avoided. Further, to chop a resource intensive IP FW into pieces, and load in serial, will cause longer loading time and more a complex booting flow, which can also be omitted.

For example, a system firmware (such like BIOS, a customer configured firmware for a field-programmable gate array, etc.) of the device 30 may act as a coordinator for a plurality of IP FW, which should be initialized on the device 30. For example, by transmitting the load message and determining the status of each RAM the processing circuitry 34 can maintain the workload of the plurality of RAM rather than merely kick off IP FW initialization. For example, if the processing circuitry 34 does not receive any information from at least one RAM of the plurality of RAM the workload of each RAM of the plurality of RAM could be fine, such that each RAM of the plurality of RAM can finish an IP initialization in a desired time. Alternatively, the processing circuitry 34 may dynamically poll and/or send adjustment messages to each μC assigned to a RAM of the plurality of RAM to adjust a RAM usage, e.g., to reassign work from a RAM with a high workload to a RAM with a lower workload. This, way, the processing circuitry 34 can combine the whole device 30 RAM resource as one whole pool to share among the plurality of IP FW. Thus, a RAM size of a μC can be independently from a complexity of an IP initialization for this μC, since the work can be reassigned to another RAM of another μC. Further, an additional compression engine or an external storage can be omitted.

In principle the processing circuitry 34 may communicate with a RAM of the plurality of RAM via a mailbox register. Further, the mailbox register may be used to communicate with the RAM via a μC assigned to the RAM. For example, in an initial setup different RAM of the plurality of RAM may be assigned to different IP initializations.

In an example, the processing circuitry 34 may be further configured to receive a response message from at least one RAM of the plurality of RAM comprising information about a status of an intellectual property, IP, initialization of the at least one RAM. This way, the processing circuitry can be informed about a process state of the IP initialization (and thus about a status of the RAM). For example, the processing circuitry 34 may receive a response message comprising information about a finished IP initialization, which may indicate that a RAM of the corresponding μC may be send to an idle mode. This RAM could be used to as target for reassigning an IP initializing of another μC. For example, the processing circuitry 34 may have received from the other μC information about an unfinished further IP initialization, which may indicate that a RAM assigned to the other μC has not enough resource to handle the IP initialization. Thus, the processing circuitry may reassign the RAM of the μC to the other μC, which may increase a finishing of the further IP initialization.

In an example, the processing circuitry 34 may be further configured to transmit an adjustment message to at least one RAM of the plurality of RAM, wherein the adjustment message is to adjust a setting of the IP initialization of the at least one RAM of the plurality of RAM. This way, the processing circuitry can inform a RAM about a reassignment to another μC or IP initialization.

In an example, the response message may comprise a request for the adjustment message. This way, the RAM (or the μC) can request an adjustment of its resources. For example, the processing circuitry 34 can be informed about usable RAM resources of the device 30. This way, the processing circuitry 34 can assign this usable RAM to an IP initialization which was not finished in predefined time or with corresponds to a RAM which indicated a work overload.

In an example, the load message may be transmitted during a round of IP initialization. The round of IP initialization may have no order and at least two RAM of the plurality of RAM may have an assigned IP initialization. Since the round of IP initialization has no order, the processing circuitry 34 can receive from each RAM of the plurality of RAM (especially from the at least two RAM with an assigned IP initialization) a response message, e.g., when an assigned IP initialization is finished. Thus, the processing circuitry 34 can be informed in an eased way about a time needed of each RAM of the plurality of RAM (especially from the at least two RAM with an assigned IP initialization) for finishing its assigned IP initialization.

In an example, the processing circuitry 34 may be further configured to receive IP initialization information from each RAM of the plurality of RAM and transmit the load message only if the IP initialization information indicates that an IP initialization of a RAM of the plurality of RAM is not finished. This way, a communication traffic between the plurality of RAM and the processing circuitry 34 can be reduced. For example, the processing circuitry may only try to reassign/balance a RAM load caused by a plurality of IP initialization, if at least one RAM of the plurality of RAM has indicated insufficient RAM resources for running an assigned IP initialization.

In an example, if one response message of the at least two RAM of the plurality of RAM with an assigned IP initialization indicates an unfinished IP initialization of the round of IP initialization, the processing circuitry 34 may be further configured to transmit a further load message during a further round of IP initialization, wherein the further round of IP initialization has no order. For example, the further round of IP initialization may comprise IP initializations for at least the same at least two RAM of the plurality of RAM of the round of IP initialization. For example, before transmitting the further load message an adjustment may have been transmitted to at least one of the at least two RAM of the plurality of RAM. This way, the processing circuitry can iteratively adjust the workload of the plurality of RAM of the device 30.

In an example, the processing circuitry 34 may be further configured to transmit a further load message during a further round of IP initialization, as long as one further response message (received at the processing circuitry 34 in response to the further load message) of the at least two RAM of the plurality of RAM with an assigned IP initialization indicates an unfinished IP initialization. This way, the processing circuitry can adjust the workload of the plurality of RAM of the device until each RAM of the plurality of RAM has finished its IP initialization, e.g., in a predefined time.

In an example, the processing circuitry 34 may be further configured to communicate with the plurality of RAM by use of at least one of a mailbox or a register. For example, the register may be a virtual register space, a physical register, a virtual register. For example, the virtual register may comprise a mailbox.

In an example, the processing circuitry 34 may be further configured to store the information about the IP initialization in a database. This way, information about the load of the RAM of the device 30 can be accessed in an eased way.

In an example, a transmission of the adjustment message may be based on the information about the IP initialization stored in the database. This way, the processing circuitry 34 can use information determined in the past, e.g., during a former boot process, to reassign an IP initialization. Thus, determined information about a status of each RAM of the plurality of RAM, e.g., an improved allocation of RAM for IP initializations, can be used for multiple boot processes, without a need to determine for each boot process a status of each RAM of the plurality of RAM.

In an example, the processing circuitry 34 may be further configured to transmit a further load message to each RAM of the plurality of RAM from which a load message was received and receive a further response message from each RAM of the plurality of RAM to which a further load message was transmitted. This may be especially done during a further round of IP initialization.

In an example, the processing circuitry 34 may be further configured to record a status of the plurality of IP initializations based on the further response messages. For example, the processing circuitry 34 may record the status of the plurality of IP initializations by storing in the database. By recording the status of the plurality of IP initializations based on the further response message a storage of unusable parameter can be prevented, e.g., parameter for which no sufficient allocation of the plurality of RAM of the device 30 could be achieved. For example, the processing circuitry 34 may only record the status of the plurality of IP initialization if each received response message indicate a finished IP initialization. This way, only a configuration for an allocation of the plurality of RAM with a sufficient round of IP initialization can be stored.

In an example, the processing circuitry 34 may be further configured to mark a resource information in a resource database based on the adjustment message. For example, the database may be the resource database. By marking the resource information in the resource database information to an allocation of the resource information can be provided. For example, a configuration of an allocation with only finished IP initialization can be marked as a preferred configuration.

In an example, the processing circuitry 34 may be further configured to mark the resource information in a resource database based on the further response message and the adjustment message. This way, the processing circuitry 34 can mark the resource information based on the messages used to determine the resource information. For example, the resource information can be assigned to a corresponding adjustment message needed to generate a desired allocation of the plurality of RAM of the device 30.

In an example, each RAM of the plurality of RAM may be assigned to a micro core. This way, an IP initialization of a RAM can be assigned to a specific μC. Thus, each μC may have its specific IP initialization.

The device 30 may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system. The hardware component may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system.

As shown in FIG. 1 the respective one or more interfaces 32 are coupled to the respective processing circuitry 34 at the processing unit 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the one or more interfaces 32, so that any data transfer that occurs over the one or more interfaces 32 and/or any interaction in which the one or more interfaces 32 may be involved may be controlled by the processing circuitry 34.

In an embodiment the processing unit 30 may comprise a memory, e.g., the (resource) database, and at least one processing circuitry 34 operably coupled to the memory and configured to perform the below mentioned method.

In examples the one or more interfaces 32 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 32 may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAS), one or more duplexers, one or more diplexers, one or more filters or filter circuitry, one or more converters, one or more mixers, accordingly adapted radio frequency components, etc.

More details and aspects are mentioned in connection with the examples described below. The example shown in FIG. 1 may comprise one or more optional additional features corresponding to one or more aspects mentioned in connection with the proposed concept or one or more examples described below (e.g., FIGS. 2-8).

FIG. 2 shows an example of a method 200 for a device. The method 200 comprises transmitting 210 a load message to each RAM of the plurality of RAM and determining 220 a status of each RAM of the plurality of RAM. The method 200 may be performed by a device describe above, e.g., with reference to FIG. 1.

In an example, the method 200 may further comprise receiving a response message from at least one RAM of the plurality of RAM comprising information about a status of an intellectual property initialization of the at least one RAM. This way, the device can be informed about a status of IP initialization of the at least one RAM, such that the device can reassign an IP initialization.

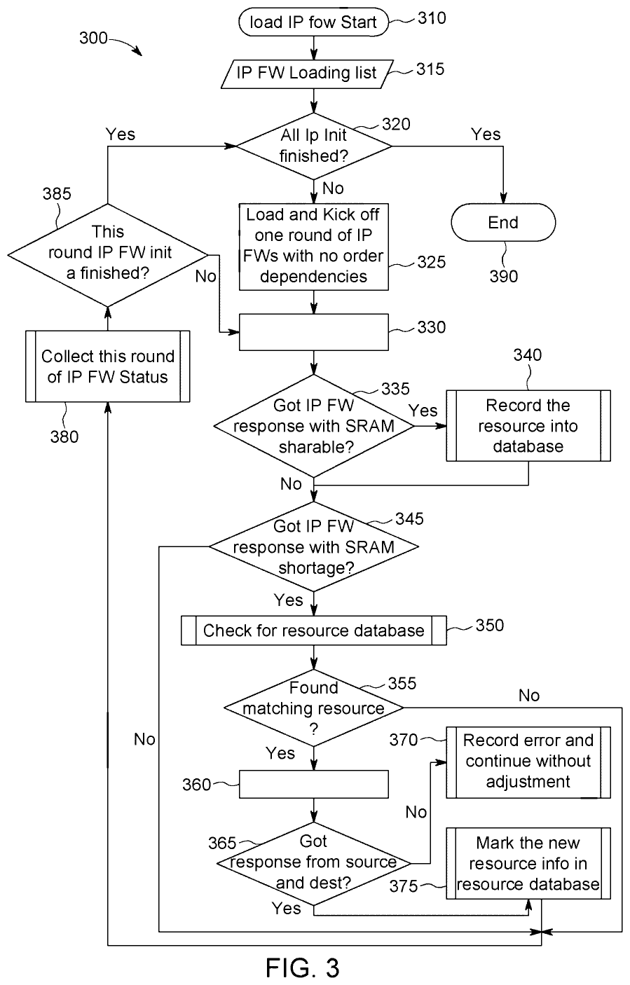

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIGS. 3-8).

FIG. 3 shows a flow diagram of another example of a method 300 for a device. The method 300 shows details of a message flow for RAM resource reuse via dynamic adjustment of IP FW by a system FW. For a device comprising a plurality of RAM, e.g., a system on a chip, in order to begin a polling and adjustment for RAM resources among different μC subsystems assigned to different IP initializations of the device the system FW may hold a list of IP subsystems. Further, the system FW may also know a loading order of the IP initializations of the different C subsystems. The system FW may load 310 an IP flow and start the method 300.

In 315 the IP FW loading list may be used to initialize the IP FW of the μC of the device. In 320 a check may be performed if all IP initializations have been finished. For example, this check can be performed by transmitting a load message and if no response message from at least one RAM assigned to a μC is received, the device can assume that all IP initializations have been finished by the corresponding RAM of the μC. Then in 390 the method 300 could be finished.

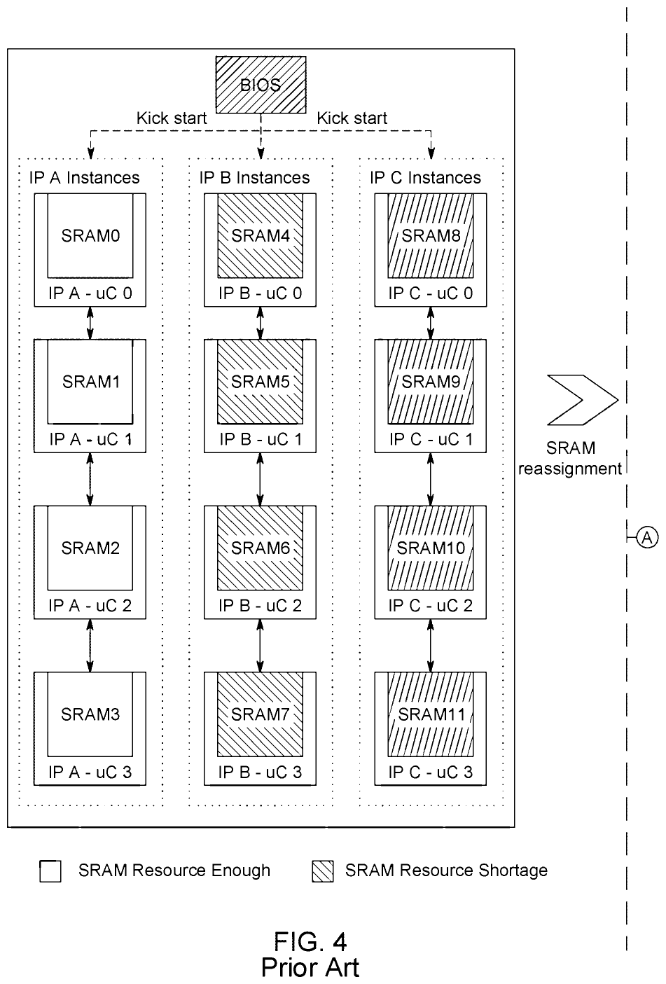

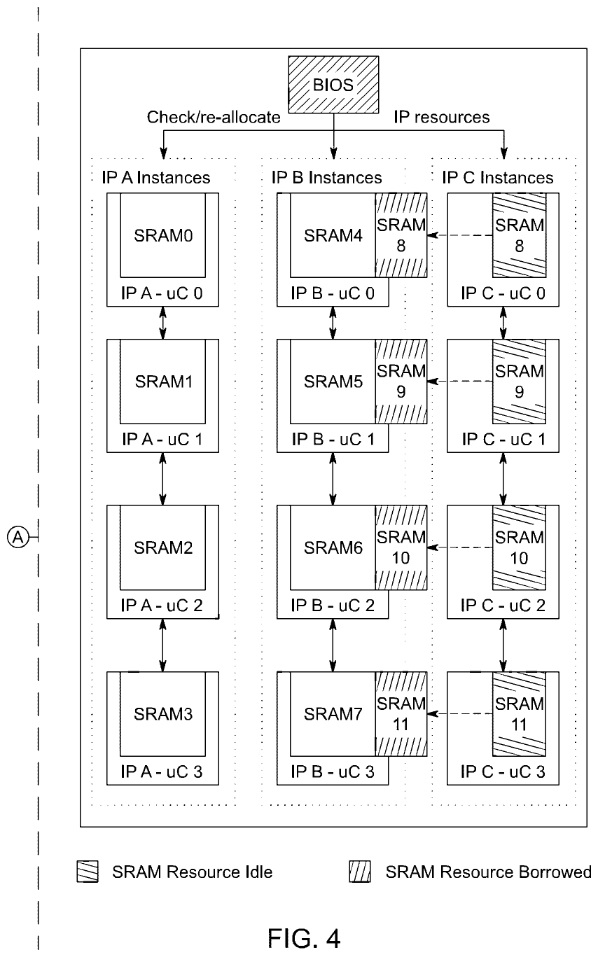

If not all IP initializations have been finished, in 325 based on the loading list the system FW may kick an IP initialization sequence round by round. Each round the IP initialization sequence without order dependencies of IP initialization can be triggered for IP initialization together. In 330 during waiting the IP initialization to finish the IP FW may transmit a load message to all μC to obtain information about a RAM resource use, e.g., by a P_MBOX_POLL_RESOURCE_OPCODE (see FIG. 4). The load message may be transmitted in a broadcast way to receive feedback from each IP initialization performed a RAM of a μC of the device.

The IP FW may receive 335 response messages, e.g., if any IP finished initialization, has a sharable resource, e.g., SRAM, could finished its IP initialization in a predefined time, etc. The IP FW may record 340 the resource information into a database.

In 345 the IP FW may check if a response message indicating a resource shortage of a μC, e.g., a SRAM, was received. If a response message indicating a shortage was received the IP FW may check 350 the database comprising information about unused/sharable(S) RAM resource.

In 355 a check may be performed if a matching resource for the shortage was found. If a matching resource was found, e.g., an unused RAM of a μC, the IP FW may transmit 360 an adjustment message, e.g., IP_MBOX_ADJUST_RESOURCE_OPCODE (see FIG. 4), to the RAM with the shortage and/or to the RAM with the sharable resource. The adjustment message may comprise correct IP information of source, destination and/or(S) RAM.

In 365 the IP FW may check if a response from the RAM with shortage and the RAM with sharable is received. If no response was received from both (RAM with shortage and RAM with sharable resource), the IP FW may record 370 an error and may continue without an adjustment of an allocation of RAM resources. If a response message was received from both, the IP FW may mark 375 the new resources allocation in a database, e.g., a resource database.

In 380 the IP FW may collect this round of IP initialization. In 385 a check may be performed if all IP initializations have been finished in this round of IP initialization. If not, the IP FW may transmit 330 a further load message. The IP FW may repeat iterate several rounds of IP initialization until a whole device booting is finished.

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIGS. 4-8).

FIG. 4 shows an example of a condition of an IP B according to the prior-art and according to another example of method for a device. The left side of FIG. 4 demonstrates the condition of IP B (four instances) running with restricted SRAM resource known from other systems. On the right side a SRAM reassignment is shown, e.g., as it could be performed by using the load message, the response message and the adjustment message described above. The SRAM resource may be mitigated after idle subsystem IP C sharing partial of its SRAMs to IP B, after each IP (A/B/C)s' communication with the IP FW, e.g., BIOS, and adjusting resourced as a result.

The vertical hatched portions of SRAMs used by IP B Instances in the right side of FIG. 4, are portions from IP C SRAMs, and by design, IP B have provision of accessibility for these SRAMs of IP C. This way, the SRAM resources of the device could be used more efficiently, e.g., decreasing a booting of the device. For example, there is no need to increase a SRAM of a device permanently. For example, an obvious time consumption caused by more rounds of images loading in order to fit big IP FW on μC can be avoided.

An example of an implementation into BIOS is shown below.

A normal communication between two FW binaries, like BIOS to Pcode, BIOS to HBM IP FW etc. may be using mailbox method through an opcode/param register, and a Data register. Generic mailbox definitions will be like:

Typedef.UINT16...................IP_MBX_COMMAND;
Typedef.UINT64...................IP_MBX_PARAM;
Typedef.UINT64...................IP_MBX_DATA;
IpMboxWriteCommand.(
..IN..UINT8.....................IpIndex,
..IN.IP_MBX_OPCODE......MboxOpcode,
..IN.IP_MBX_PARAM.......MboxParam
..);
IpMailboxReadData.(
..IN..UINT8..................IPIndex,
..OUT.IP_MBX_DATA...*IpData
..);

Below amendments in the pseudo code are shown to include the load message, the response message and the adjustment message in BIOS side.

Two opcodes can be added (third and fourth line) The mailbox opcodes for polling and resource adjustment can be like below pseudo code.

typedef.enum{
..IP_MBOX_INITIALIZE_OPCODE............................=.0x00,
..IP_MBOX_POLL_RESOURCE_OPCODE...................=.0x01,
..IP_MBOX_INITIALIZE_RESOURCE_OPCODE...........=.0x02,
...
.. IP_MBOX_MAX_OPCODE
; .IP_MBX_OPCODE;

Further, a mailbox parameter structures for polling/adjusting for resource may be added, like below, e.g., a request parameter from BIOS to IP for opcode IP_MBOX_POLL_RESOURCE_OPCODE:

typedef.union.{
..struct.{
{
....UINT64.IpIndex..............:.4;....//.IP.index.that.has.uCore.subsystem,.and.sup-
port.this.polling
....UINT64.PollSramSize......:.1;....//.Poll.for.SRAM.size.in.this.request..0.-
skip.in.polling,.1.-.need.uCore.return.this.info
....UINT64.PollFootPrintSize..:.1;....//.Poll.for.running.size.in.this.request..0.-
skip.in.polling,.1.-need.uCore.return.this.info
....UINT64.PollCurrentStatus..:.1;....//.Poll.for.SRAM.size.in.this.request.0.-
skip.in.polling,.1.-.need.uCore.return.this.info
....UINT64.RSVD...............:.57;...//.reserved.for.future.usage
..}Bits;
..Unit64.Data;
}.MBOX_PARAM_RESOURCE_POLLING;

Further, a request parameter from BIOS to IP for opcode IP_MBOX_ADJUST_RESOURCE_OPCODE may be added:
typedef⋅union⋅{

..struct.{
....UINT64.IpSourceIndex..............:.4;.....//.IP.index.that.can.share.SRAM.re-
source.out.
....UINT64.IpDestinationIndex.........:.4;....//.IP.index.that.need.SRAM.resource.
....UINT64.SramSharableBase..........:.22;...//.SRAM.base.ad-
dress.that.can.be.shared,.this.is.higer.bit.[31:10].in.K.size
....UINT64.SramSharableSize...........:.8;....//.Sharable.SRAM.from.source.IP.to.desti-
nation.IP.in.K,.so.max.is.256K.SRAM.can.be.shared
....UINT64.RSVD........................:.26;...//.reserved.for.future.usage
..}Bits;
..Unit64.Data;
}.MBOX_PARAM_RESOURCE_ADJUST;

The mailbox data return for polling/adjusting for resource may be like below. Responded data for opcode IP_MBOX_POLL_RESOURCE_OPCODE:

typedef.union.{
..struct.{
....UINT64.IpIndex.........................:.4;....//.IP.index.that.has.uCore.subsys-
tem,.and.support.this.polling.
....UINT64.SramTotalSize................:.8;....//.IP.SRAM.physical.size.in.K
....UINT64.SramSharableSize...........:.8;....//.IP.canshare.out.SRAM.in.K
....UINT64.SramSharableBase..........:.22;...//.SRAM.base.ad-
dress.that.can.be.shared, .this.is.higer.bit.[31:10] .in.K.size
....UINT64.SramSortageSize.............:.8;...//.IP.need.extra.SRAM.size.in.K
....UINT64.InitializeStatus................:.8;...//.IP.status, .0: .IP.FW.not.started;
........................................................//..............1:.IP.FW.init.in.pro-
gress.and.SRAM.still.in.use
........................................................//..............2:.IP.FW.init.fin-
ished.and.SRAM.idle
........................................................//..............3:.IP.FW.init.finished.and.shar-
able.SRAM.(Base.Size).can.be.returned
....UINT64.RSVD........................:.6;...//.reserved.for.future.usage
..}Bits;
..Unit64.Data;
}.MBOX_DATA_RESOURCE_Polling;

The responded data for opcode IP_MBOX_ADJUST_RESOURCE_OPCODE, from source IP and destination IP may be:

typedef.union.{
..struct.{
....UINT64.IpSourceIndex........................:.4;.....//.IP.index.that.can.share.SRAM.re-
source.out.
....UINT64.SramSharableBase.........:.22;...//.SRAM.base.ad-
dress.that.can.be.shared, .this.is.higer.bit.[31:10] .in.K.size
....UINT64.SramSharableSize...........:.8;....//.Sharable.SRAM.from.source.IP.to.desti-
nation.IP.in.K,.so.max.is.256K.SRAM.can.be.shared
....UINT64.SramRemovalFinished.....:.1;....//.The.sharable.SRAM.is.already.re-
moved.from.local.IP.resource.map
....UINT64.RSVD........................:.29;...//.reserved.for.future.usage
..}Bits;
..Unit64.Data;
}. MBOX_DATA_RESOURCE_ADJUST_SOURCE;
typedef.union.{
..struct{
....UINT64.IpIndex........................:.4;.....//.IP.index.as.destina-
tion.that.got.SRAM.resource.shared.from.ohter.IP.
....UINT64.SramSharableBase.........:.22;...//.SRAM.base.ad-
dress.that.can.be.shared, .this.is.higer.bit.[31:10] .in.K.size
....UINT64.SramSharableSize...........:.8;....//.Sharable.SRAM.from.source.IP.to.desti-
nation.IP.in.K, .so.max.is.256K.SRAM.can.be.shared
....UINT64.SramAddingFinished.......:.1;....//.Thesharable.SRAM.is.al-
ready.added.in.target.IP.resource.map
....UINT64.RSVD........................:.29;...//.reserved.for.future.usage
..}Bits;
..Unit64.Data;
}.MBOX_DATA_RESOURCE_ADJUST_DESTINATION;

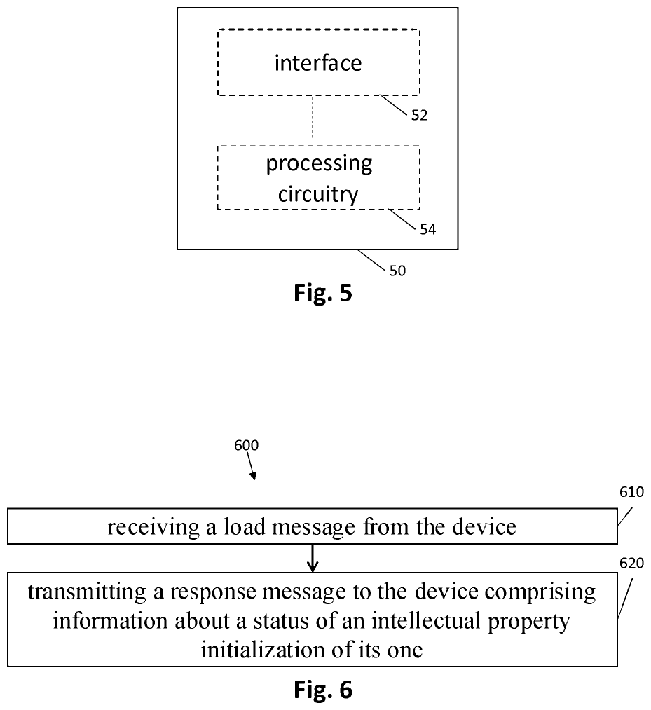

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIGS. 5-8).

FIG. 5 shows a block diagram of an example of a RAM 50. The RAM 50 comprises one or more interfaces 52 configured to communicate with a device as described above (e.g., device as described with reference to FIG. 1) and a processing circuitry 54 configured to control the one or more interfaces 52. Further, the processing circuitry 54 is configured to receive a load message from the device and to transmit a response message to the device comprising information about a status of an intellectual property, IP, initialization of its one. This way, the RAM 50 can inform the device about a status of an IP initialization. Thus, the RAM may enable the device to reassign a resource of the RAM 50, e.g., if the RAM 50 indicates a sharable resource, a high workload, etc. The RAM 50 may be assigned to a μC. The RAM 50 may be the counterpart to the device as described above.

For example, a resources intensive IP initialization of an IP FW may run on the RAM 50. Maintaining the IP initialization, e.g., reassigning the IP initialization (e.g., at least partially) to another μC, can improve the IP initialization of the IP FW, since the IP FW is no longer initialized only by the RAM 50.

In an example, the processing circuitry 54 may be further configured to receive an adjustment message from the device, wherein the adjustment message is to adjust a setting of IP initialization of its own. This way, the RAM 50 can adjust the setting of IP initialization, e.g., remove a part of a resource intensive IP initialization from the IP initialization.

In an example, the response message may comprise a request for the adjustment message. This way, the RAM 50 can request the adjustment message, e.g., if an IP initialization could not be finished by the RAM 50.

In an example, the processing circuitry 54 may be further configured to adjust at least one of a RAM size or a RAM range based on the adjustment message. This way, the RAM 50 can adjust resources of its own to a reassignment of IP initialization performed by the device.

In an example, the response message comprises information about at least one of a RAM size or a RAM range. This way, the RAM 50 can inform the device about sharable resources. For example, the device may store this information in a database as described above.

In an example, the RAM 50 may be assigned to a micro core. This way, an IP initialization of a RAM 50 can be assigned to a specific μC. Thus, each μC may have its specific IP initialization.

The device 50 may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system. The hardware component may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system.

As shown in FIG. 5 the respective one or more interfaces 52 are coupled to the respective processing circuitry 54 at the processing unit 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the one or more interfaces 52, so that any data transfer that occurs over the one or more interfaces 52 and/or any interaction in which the one or more interfaces 52 may be involved may be controlled by the processing circuitry 54.

In an embodiment the processing unit 50 may comprise a memory and at least one processing circuitry 54 operably coupled to the memory and configured to perform the below mentioned method.

In examples the one or more interfaces 52 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 52 may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIGS. 1-4) and/or below (e.g., FIGS. 6-8).

FIG. 6 shows an example of a method 600 for a RAM. The method 600 comprises receiving 610 a load message from the device and transmitting 620 a response message to the device comprising information about a status of an intellectual property initialization of its one. The message may be performed by the RAM as described, e.g., with reference to FIG. 5.

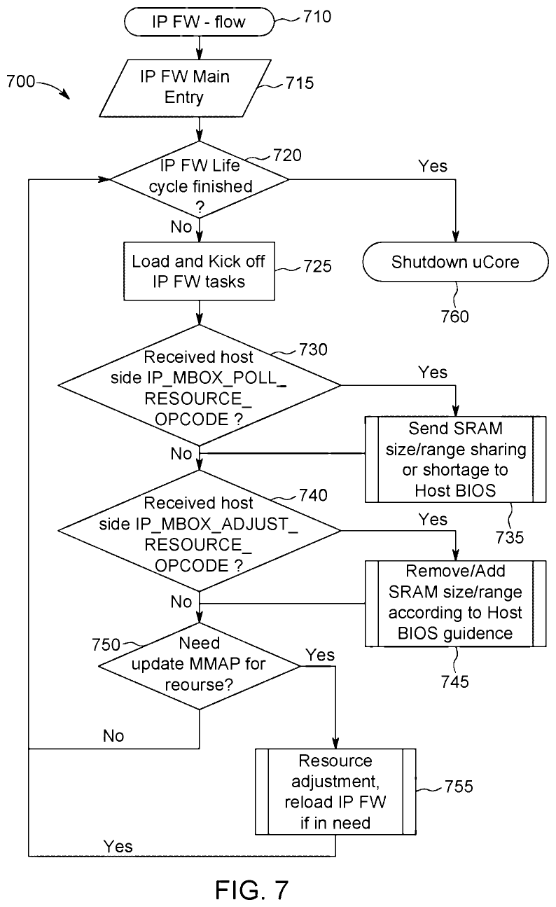

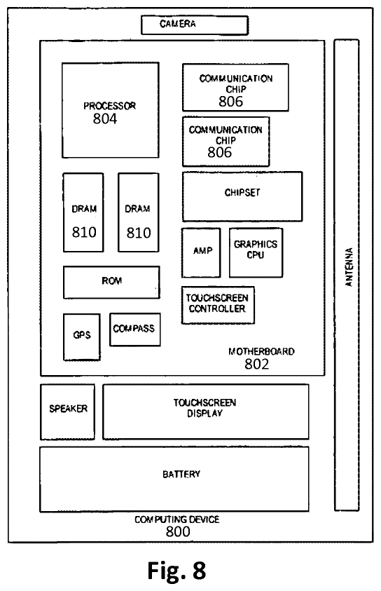

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIGS. 1-5) and/or below (e.g., FIGS. 7-8).

FIG. 7 shows a flow diagram of another example of a method 700 for a RAM. FIG. 7 shows an IP FW flow 700 on a μC (also referred as μCore). The IP FW flow 700 may perform IP initializations, e.g., different IP initialization tasks at the same time. Further, the IP FW flow 700 may listen to a system FW, e.g., BIOS for key messages, e.g., a load message, an adjustment message. Further, the IP FW flow 700 may respond to the key messages via checking for its own capabilities. The IP FW flow may be started 710. In 715 an IP FW Main entry may be performed. In 720 a check if an IP FW Life cycle is finished may be performed. If the IP FW Life cycle is finished, the RAM, respectively the μC may be shut down 760.

If the IP FW Life cycle was not finished, the IP FW may a task of IP initialization, e.g., one by one locally. In 730 a paralleling listening thread may be used to capture any key messages, e.g., a load message. The IP RAM/μC may check the key messages, and if it is a load message, e.g., an IP_MBOX_POLL_RESOURCE_OPCODE, then the RAM/μC may gather and transmit 735 self SRAM resource info back to system FW.

If the key message is an adjustment message 740, e.g., an IP_MBOX_ADJUST_RESOURCE_OPCODE, and the adjustment source/destination index match this IP initialization, then the RAM/μC may perform 745 a corresponding action.

For example, if this is a source IP, the related SRAM resource may be removed 745 from current memory map, and future execution may not use it. Further, an acknowledgment message can be transmitted to the system FW, e.g., a MBOX_DATA_RESOURCE_ADJUST_SOURCE format, as an acknowledgement of the performed adjustment.

For example, if this is a destination IP, the related SRAM resource may be added 745 into a current memory map, and future execution may begin to use it. Further, an acknowledgment message can be transmitted to the system FW, e.g., a MBOX_DATA_RESOURCE_ADJUST_DESTINATION format, as an acknowledgement of the performed adjustment.

If this IP finishes initialization, but a life cycle is not ended, the listening thread may be still active, to listen 750 to further key messages, e.g., to leverage/share out resource to other Ips 755.

After the IP initialization is done, the shared SRAM can return using responding data, e.g., a MBOX_DATA_RESOURCE_POLLING, to indicate the related SRAM can return to a similar sequence, just the trigger is not shortage but returning of resource (e.g., a MBOX_DATA_RESOURCE_POLLING. InitializeStatus=3).

If this IP FW Life cycle is finished, then the RAM/μC may be shut down 760.

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIGS. 1-6) and/or below (e.g., FIG. 8).

FIG. 8 shows a computing device 800. The computing device 800 houses a board 802. The board 802 may include a number of components, including but not limited to a processor 804 and at least one communication chip 806. A device as described above (e.g., with reference to FIG. 1) may be comprised by the processor 804 as shown in FIG. 8.

The processor 804 is physically and electrically coupled to the board 802. In some examples the at least one communication chip 806 is also physically and electrically coupled to the board 802. In further examples, the communication chip 806 is part of the processor 804.

Depending on its applications, computing device 800 may include other components that may or may not be physically and electrically coupled to the board 802. These other components include, but are not limited to, volatile memory (e.g., DRAM 810, SRAM), e.g., as described above (e.g., with reference to FIG. 5), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 806 enables wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing device 800 includes an integrated circuit die packaged within the processor 804. In some examples, the integrated circuit die of the processor includes one or more devices that are assembled in an ePLB or eWLB based POP package that that includes a mold layer directly contacting a substrate, in accordance with examples. The term “processor” may refer to any device or portion of a device that processes electronic data from registers and/or memory to transform that electronic data into other electronic data that may be stored in registers and/or memory.

The communication chip 806 also includes an integrated circuit die packaged within the communication chip 806. In accordance with another example, the integrated circuit die of the communication chip includes one or more devices that are assembled in an ePLB or eWLB based POP package that that includes a mold layer directly contacting a substrate, in accordance with examples.

More details and aspects are mentioned in connection with the examples described above. The example shown in FIG. 8 may comprise one or more optional additional features corresponding to one or more aspects mentioned in connection with the proposed concept or one or more examples described above (e.g., FIGS. 1-7).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, functions, -processes or -operations.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and sub combinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

An example (e.g., example 1) relates to a device, comprising one or more interfaces configured to communicate with a plurality of random-access memories (RAM) and processing circuitry configured to control the one or more interfaces and to transmit a load message to each RAM of the plurality of RAM and determine a status of each RAM of the plurality of RAM.

An example (e.g., example 1a) relates to a device, comprising means for processing and means for storing information, wherein the device is configured to transmit a load message to each RAM of the plurality of RAM and determine a status of each RAM of the plurality of RAM.

Another example (e.g., example 2) relates to a previously described example (e.g., example 1) wherein the processing circuitry is further configured to receive a response message from at least one RAM of the plurality of RAM comprising information about a status of an intellectual property, IP, initialization of the at least one RAM.

Another example (e.g., example 3) relates to a previously described example (e.g., one of the examples 2-3) wherein the processing circuitry is further configured to transmit an adjustment message to at least one of the plurality of RAM, wherein the adjustment message is to adjust a setting of IP initialization of the at least one RAM of the plurality of RAM.

Another example (e.g., example 4) relates to a previously described example (e.g., one of the examples 1-3) wherein the response message comprises a request for the adjustment message.

Another example (e.g., example 5) relates to a previously described example (e.g., one of the examples 1-4) wherein the load message is transmitted during a round of IP initialization, wherein the round of IP initialization has no order and at least two RAM of the plurality of RAM have an assigned IP initialization.

Another example (e.g., example 6) relates to a previously described example (e.g., example 5) wherein the processing circuitry is further configured to receive IP initialization information from each RAM of the plurality of RAM; and transmit the load message only if the IP initialization information indicates that an IP initialization of a RAM of the plurality of RAM is not finished.

Another example (e.g., example 5) relates to a previously described example (e.g., one of the examples 5-6) wherein if one response message of the at least two RAM of the plurality of RAM with an assigned IP initialization indicates an unfinished IP initialization of the round of IP initialization, the processing circuitry is further configured to transmit a further load message during a further round of IP initialization, wherein the further round of IP initialization has no order.

Another example (e.g., example 8) relates to a previously described example (e.g., example 7) wherein the processing circuitry is further configured to transmit a further load message during a further round of IP initialization, as long as one further response message of the at least two RAM of the plurality of RAM with an assigned IP initialization indicates an unfinished IP initialization.

Another example (e.g., example 9) relates to a previously described example (e.g., one of the examples 1-8) wherein the processing circuitry is further configured to communicate with the plurality of RAM by use of at least one of a mailbox or a register.

Another example (e.g., example 10) relates to a previously described example (e.g., one of the examples 1-9) wherein the processing circuitry is further configured to store the information about the IP initialization in a database.

Another example (e.g., example 11) relates to a previously described example (e.g., example 10) wherein a transmission of the adjustment message is based on the information about the IP initialization stored in the database.

Another example (e.g., example 12) relates to a previously described example (e.g., example 11) wherein the processing circuitry is further configured to transmit a further load message to each RAM of the plurality of RAM from which a load message was received; and receive a further response message from each RAM of the plurality of RAM to which a further load message was transmitted.

Another example (e.g., example 13) relates to a previously described example (e.g., example 12) wherein the processing circuitry is further configured to record a status of the plurality of IP initializations based on the further response messages.

Another example (e.g., example 14) relates to a previously described example (e.g., one of the examples 2-13) wherein the processing circuitry is further configured to mark a resource information in a resource database based on the adjustment message.

Another example (e.g., example 15) relates to a previously described example (e.g., example 14) mark a resource information in a resource database based on the further response message and the adjustment message.

Another example (e.g., example 16) relates to a previously described example (e.g., one of the examples 1-15) wherein each RAM of the plurality of RAM is assigned to a micro core.

An example (e.g., example 17) relates to a random-access memory (RAM), comprising one or more interfaces configured to communicate with a device; and processing circuitry configured to control the one or more interfaces and to receive a load message from the device and transmit a response message to the device comprising information about a status of an intellectual property, IP, initialization of its one.

Another example (e.g., example 18) relates to a previously described example (e.g., example 17) wherein the processing circuitry is further configured to receive an adjustment message from the device, wherein the adjustment message is to adjust a setting of IP initialization of its own.

Another example (e.g., example 19) relates to a previously described example (e.g., one of the examples 17-18) wherein the response message comprises a request for the adjustment message.

Another example (e.g., example 20) relates to a previously described example (e.g., one of the examples 18-19) wherein the processing circuitry is further configured to adjust at least one of a RAM size or a RAM range based on the adjustment message.

Another example (e.g., example 21) relates to a previously described example (e.g., one of the examples 17-20) wherein the response message comprises information about at least one of a RAM size or a RAM range.

An example (e.g., example 22) relates to a method, comprising transmitting a load message to each RAM of the plurality of RAM and determining a status of each RAM of the plurality of RAM.

Another example (e.g., example 23) relates to a previously described example (e.g., example 22) further comprising receiving a response message from at least one RAM of the plurality of RAM comprising information about a status of an intellectual property initialization of the at least one RAM.

An example (e.g., example 24) relates to a method, comprising receiving a load message from the device and transmitting a response message to the device comprising information about a status of an intellectual property initialization of its one.

An example (e.g., example 25) relates to a non-transitory, computer-readable medium comprising a program code that, when the program code is executed on a computer, a processor, or a programmable hardware component, performs the method of the above examples (e.g., one of the examples 22-23).

An example (e.g., example 25a) relates to a computer program having a program code for performing the method of the above examples (e.g., one of the examples 22-23), when the computer program is executed on a computer, a processor, or a programmable hardware component.

An example (e.g., example 26) relates to a non-transitory, computer-readable medium comprising a program code that, when the program code is executed on a computer, a processor, or a programmable hardware component, performs the method of the above examples (e.g., example 24).

An example (e.g., example 26a) relates to a computer program having a program code for performing the method of the above examples (e.g., example 24), when the computer program is executed on a computer, a processor, or a programmable hardware component.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A device, comprising:
one or more interfaces configured to communicate with a plurality of random-access memories (RAM); and
processing circuitry configured to control the one or more interfaces and to:
transmit a load message to each RAM of the plurality of RAM; and
determine a status of each RAM of the plurality of RAM.

2. The device according to claim 1, wherein
the processing circuitry is further configured to receive a response message from at least one RAM of the plurality of RAM comprising information about a status of an intellectual property, IP, initialization of the at least one RAM.

3. The device according to claim 1, wherein
the processing circuitry is further configured to transmit an adjustment message to at least one of the plurality of RAM, wherein the adjustment message is to adjust a setting of IP initialization of the at least one RAM of the plurality of RAM.

4. The device according to claim 3, wherein
the response message comprises a request for the adjustment message.

5. The device according to claim 1, wherein
the load message is transmitted during a round of IP initialization, wherein the round of IP initialization has no order and at least two RAM of the plurality of RAM have an assigned IP initialization.

6. The device according to claim 5, wherein
the processing circuitry is further configured to:
receive IP initialization information from each RAM of the plurality of RAM; and
transmit the load message only if the IP initialization information indicates that an IP initialization of a RAM of the plurality of RAM is not finished.

7. The device according to claim 5, wherein
if one response message of the at least two RAM of the plurality of RAM with an assigned IP initialization indicates an unfinished IP initialization of the round of IP initialization, the processing circuitry is further configured to transmit a further load message during a further round of IP initialization, wherein the further round of IP initialization has no order.

8. The device according to claim 7, wherein
the processing circuitry is further configured to transmit a further load message during a further round of IP initialization, as long as one further response message of the at least two RAM of the plurality of RAM with an assigned IP initialization indicates an unfinished IP initialization.

9. The device according to claim 1, wherein
the processing circuitry is further configured to communicate with the plurality of RAM by use of at least one of a mailbox or a register.

10. The device according to claim 1, wherein
the processing circuitry is further configured to store the information about the IP initialization in a database.

11. The device according to claim 10, wherein
a transmission of the adjustment message is based on the information about the IP initialization stored in the database.

12. The device according to claim 11, wherein
the processing circuitry is further configured to:
transmit a further load message to each RAM of the plurality of RAM from which a load message was received; and
receive a further response message from each RAM of the plurality of RAM to which a further load message was transmitted.

13. The device according to claim 12, wherein
the processing circuitry is further configured to record a status of the plurality of IP initializations based on the further response messages.

14. The device according to claim 2, wherein
the processing circuitry is further configured to mark a resource information in a resource database based on the adjustment message.

15. The device according to claim 14, wherein
the processing circuitry is further configured to mark a resource information in a resource database based on the further response message and the adjustment message.

16. The device according to claim 1, wherein
each RAM of the plurality of RAM is assigned to a micro core.

17-21. (canceled)

22. A method, comprising:
transmitting a load message to each random access memory (RAM) of a plurality of RAM; and
determining a status of each RAM of the plurality of RAM.

23. (canceled)

24. A non-transitory, computer-readable medium comprising a program code that, when the program code is executed on a computer, a processor, or a programmable hardware component, performs the method according to claim 22.

25. (canceled)
